(19) United States
(12) Patent Application Publication
(10) Pub. No.: US 2003/0043788 A1
(43) Pub. Date: Mar. 6, 2003

(54) Packet repeater in asymmetrical transmissions

(75) Inventors: Teruyuki Hasegawa, Saitama-shi (JP); Yutaka Miyake, Saitama-shi (JP); Toru Hasegawa, Shiki-shi (JP); Kouji Nakao, Saitama-shi (JP)

Correspondence Address: Dike, Bronstein, Roberts & Cushman, Intellectual Property Practice Group, Edwards & Angell, LLP, P. O. Box 9169, Boston, MA, 02209, US

(73) Assignee: KDDI Corporation

(21) Appl. No.: 10/235,218

(22) Filed: Sep. 4, 2002

(30) Foreign Application Priority Data
Sep. 6, 2001 (JP) P2001-270331

(51) Int. Cl. H04L 12/66; H04L 12/56; H04J 3/00

(52) U.S. Cl. 370/352; 370/315; 370/401; 370/474

(57) ABSTRACT

A packet repeater (e.g., gateway) is applicable to an integrated digital network system which incorporates a first network (e.g., Internet) and a second network (e.g., satellite communication system) comprising an upstream line and a downstream line which are asymmetrical with respect to each other in data transmission speed. In the packet repeater, specific data (e.g., TCP data) are extracted from plural packets and are assembled together into a single transmission packet on the basis of the maximal amount of storable data, which is greater than the maximal segment size notified from a receiver under conditions in which the reception window size fulfills the maximal amount of storable data. The packet repeater has reception acknowledgement response agency functions for provisionally sending back a reception acknowledgement response in reply to the prescribed number of packets transmitted via the first network before receiving a reception acknowledgement response from the receiver receiving the transmission packet.

### BACKGROUND OF THE INVENTION

1. Field of the Invention

This invention relates to apparatuses and methods for repeating packets in asymmetrical transmissions in which data transmission speeds are asymmetrical between upstream and downstream lines for use in reception and transmission of packets.

2. Description of the Related Art

Conventionally, packet repeaters are widely used for repeating packets between different flows or lines in data communications. Gateway devices are known as typical examples of packet repeaters.

In asymmetrical transmissions, data transmission speeds are made asymmetrical with respect to upstream and downstream respectively, for example, uplink and downlink lines in satellite communications using satellites, and mobile communication networks established between mobile terminals and base stations. In general, downstream lines used for transmission to subscribers are commonly shared by numerous subscribers; therefore, data transmission speeds used in downstream lines are greatly increased compared with data transmission speeds used in upstream lines for data reception from subscribers.

Packet repeaters are conventionally used to repeat packets between satellite communication lines and Internet lines. In packet communications incorporating TCP (Transmission Control Protocol) and the like, receivers normally send back reception acknowledgement responses (e.g., ACK packets) for flow controls with respect to received packets. Herein, packet repeaters control packet transmissions based on reception conditions of ACK packets.

As described above, in asymmetrical transmissions, data transmission speeds for upstream lines, which are used to receive data, are smaller than data transmission speeds for downstream lines that are used to transmit data. For this reason, the conventional packet repeaters suffer from the following problems when repeating packets in asymmetrical transmissions using different data transmission speeds for upstream and downstream lines respectively.

Suppose that by using a high data transmission speed in the downstream line, a packet repeater repeats and transmits numerous packets to a receiver. In this case, the receiver sends back ACK packets to the upstream line with respect to received packets. This may cause a shortage of transmission capacity in the upstream line having a small data transmission speed. In other words, congestion may occur in the upstream line. Due to the occurrence of the congestion, the arrival of the ACK packet given from the receiver may be delayed over the prescribed retransmission wait time, which is set in advance. In addition, when packet loss occurs, the packet repeater proceeds to retransmit packets. This may cause a reduction of throughput in data transmission (or data transmission efficiency) in packet communication.

### SUMMARY OF THE INVENTION

It is an object of the invention to provide an apparatus and a method for repeating packets in asymmetrical transmissions in which data transmission speeds in upstream lines, which are used to receive data, are lower than data transmission speeds in downstream lines that are used to transmit data, wherein a throughput in data transmission (or data transmission efficiency) is improved.

A packet repeater (e.g., gateway) of this invention is applicable to an integrated digital network system which incorporates a first network (e.g., Internet) and a second network (e.g., satellite communication system) comprising an upstream line and a downstream line which are asymmetrical with each other in data transmission speed.

The packet repeater comprises a first network adaptive communicator for allowing bidirectional communications of packets via the first network, a second network adaptive communicator for allowing bidirectional communications of packets via the second network, and a packet assembler for extracting specific data (e.g., TCP data) from plural packets received by the first network adaptive communicator and for assembling together the specific data into a single transmission packet, which is transmitted by the second network adaptive communicator. In particular, the upstream line is reduced in data transmission speed compared with the downstream line.

In the above, the packet assembler is controlled in such a way that the maximal amount of storable data per one transmission packet is increased to be greater than the maximal segment size notified from a receiver interconnected with the second network. Herein, the packet assembler is instructed to assemble together plural packets in the form of a single transmission packet on the basis of the maximal amount of storable data under conditions in which the reception window size notified from the receiver fulfills the maximal amount of storable data.

In addition, the packet repeater has reception acknowledgement response agency functions for provisionally sending back a reception acknowledgement response in reply to the prescribed number of packets transmitted via the first network before receiving a reception acknowledgement response from the receiver receiving the transmission packet.

Therefore, it is possible to reduce the congestion in upstream lines away from receivers towards the gateway. As a result, it is possible to reduce the retransmission frequency of packets due to the congestion. Thus, it is possible to improve the data transmission efficiency.

### BRIEF DESCRIPTION OF THE DRAWINGS

These and other objects, aspects, and embodiments of the present invention will be described in more detail with reference to the following drawings, in which:

FIG. 1 is a block diagram showing the overall configuration of a satellite communication system incorporating a server and terminals as well as a packet repeater, i.e., a gateway in accordance with a preferred embodiment of the invention;

FIG. 2 is a block diagram showing the internal configuration of the gateway shown in FIG. 1; and

FIG. 3 is a sequence diagram showing relationships of mutual operations between the server, gateway, and terminal in packet repeating processing.

### DESCRIPTION OF THE PREFERRED EMBODIMENT

This invention will be described in further detail by way of examples with reference to the accompanying drawings.

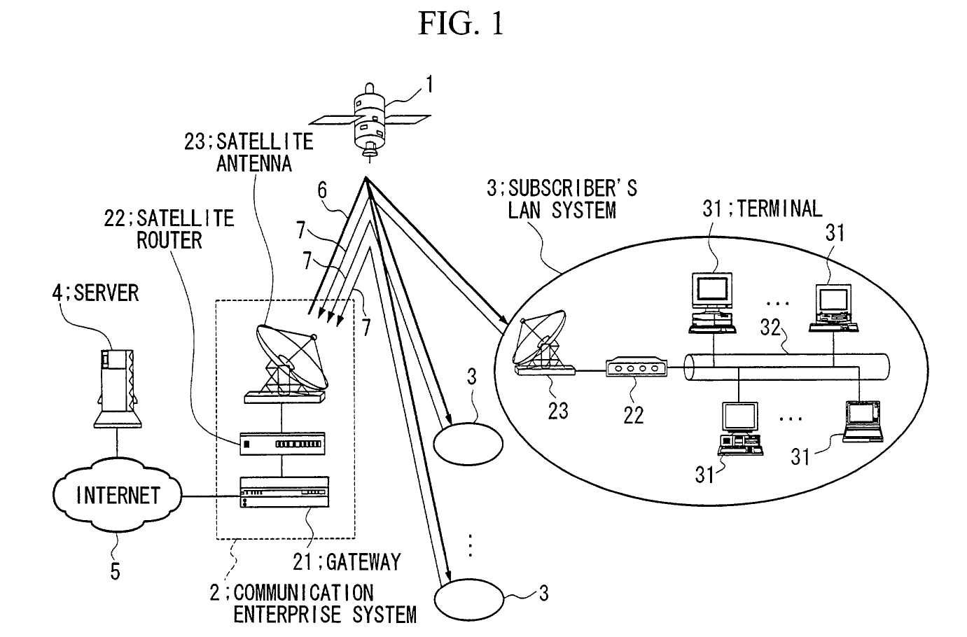

FIG. 1 is a block diagram showing the overall configuration of a satellite communication system providing a gateway 21, which acts as a packet repeater in accordance with the preferred embodiment of the invention. Herein, reference numeral 1 designates a communication satellite, and reference numeral 2 designates a communication enterprise system that performs communications using the communication satellite 1 over satellite communication lines 6 and 7. The communication enterprise system 2 is constituted by the gateway 21 as well as a satellite router 22 and a satellite antenna 23. Reference numeral 3 designates a local area network (LAN) installed in the subscriber who has prescribed contracts with the communication enterprise system 2, which will be referred to as a subscriber's LAN system. Specifically, the subscriber's LAN system 3 comprises terminals 31, a satellite router 22, and a satellite antenna 23, all of which are interconnected together by a local area network (LAN) 32. Numerous subscriber's LAN systems 3 are capable of performing communications with the communication enterprise system 2 via the communication satellite 1.

Reference numeral 4 designates a server that performs data communications with terminals 31 arranged in subscriber's LAN systems 3 by using packets, which are formed based on the TCP (Transmission Control Protocol) and IP (Internet Protocol). Reference numeral 5 designates a computer network such as the Internet, over which the server 4 and the gateway 21 are interconnected with each other.

In the satellite communication system of FIG. 1, the communication enterprise system 2 performs downstream communications with plural subscriber's LAN systems 3 over a single satellite communication line 6, wherein the term ‘downstream communications’ refers to data communications directed from the communication enterprise system 2 to the subscriber's LAN system 3. In contrast, the subscriber's LAN systems 3 use independent satellite communication lines 7 to perform upstream communications, which is directed from the subscriber's LAN system to the communication enterprise system 2. Data transmission speeds in upstream satellite lines 7 are lower than data transmission speeds in downstream satellite lines 6. For example, the downstream satellite line 6 provides a data transmission speed of 10 megabits per second, while the upstream satellite line 7 provides a data transmission speed of 64 kilobits per second.

The gateway 21 receives packets from the server 5 over the Internet 5, so that it outputs received packets to the satellite router 22 in order to transfer them towards the terminals 31 arranged in the subscriber's LAN system 3 via the downstream satellite line 6. In contrast, each terminal 31 is capable of transmitting packets towards the communication enterprise system 2 via the upstream satellite line 7, wherein the packets are received by the satellite antenna 22 and the satellite router 23. Then, the communication enterprise system 2 may output the received packets onto the Internet 5, whereas it discards reception acknowledgement response packets (ACK packets).

The gateway 21 produces ACK packets, which are attached to received packets given from the server 4 over the Internet 5. That is, the gateway 21 has agency functions of reception acknowledgement responses in transmissions towards the server 4. In agency functions, the gateway 21 promptly starts transmitting ACK packets, which were given from the server 4 with respect to packets transmitted to the terminal 31, before completion of reception of packets actually transmitted thereto from the terminal 31. Due to agency functions, the gateway 21 is capable of controlling the server 4 to adequately transmit next packets therefor.

In addition, the gateway 21 reassembles plural packets, transmitted thereto from the server 4, into a single packet, which is transmitted to the terminal 31. Generally speaking, the terminal 31 should return plural ACK packets with respect to plural packets transmitted thereto from the server 4. However, the present embodiment is designed in such a way that the terminal 31 is merely required to return a single ACK packet with respect to plural packets transmitted thereto from the server 4.

The gateway 21 employs IP fragmentation in which packets, which should be transmitted to the server 4, are each divided into prescribed lengths, each of which is transmittable over the downstream satellite line 6. That is, each packet is subjected to fragmentation into the prescribed number of small-size data units, which are sequentially transmitted towards the server 4 over the Internet 5. In short, the IP fragmentation is the processing in which TCP data transferred between IP layers are divided into prescribed data lengths in conformity with the physical layer.

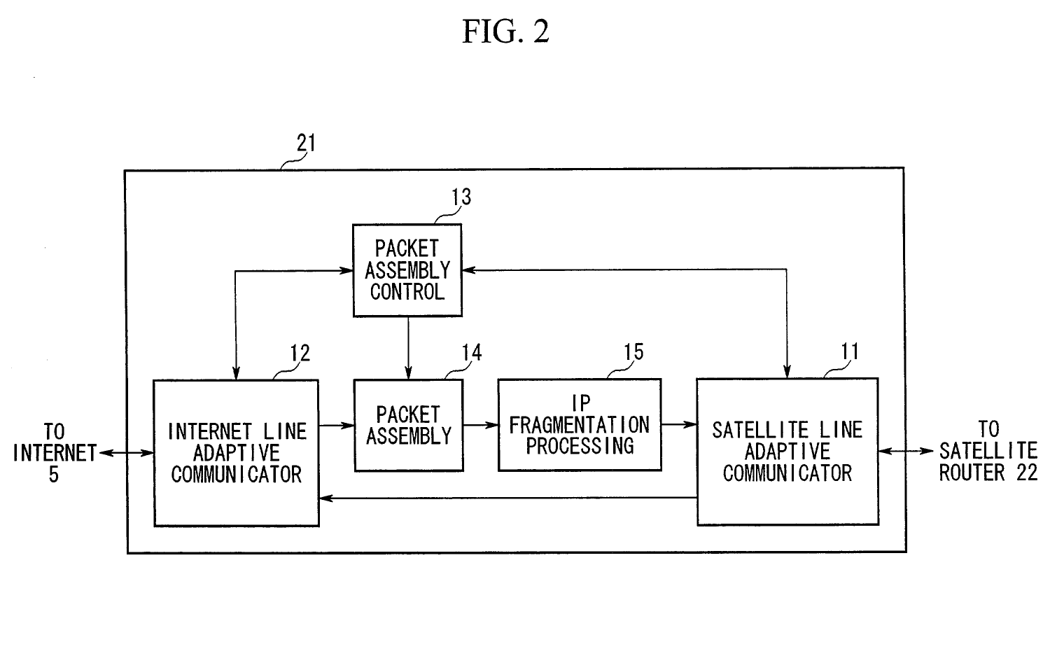

FIG. 2 is a block diagram showing the internal configuration of the gateway 21 shown in FIG. 1. That is, the gateway 21 comprises various blocks 11 to 15, wherein a satellite line adaptive communicator 11 performs packet communications with the subscriber's LAN systems 3 via the satellite lines 6 and 7, and an Internet line adaptive communicator 12 performs packet communications with the server 4 over the Internet 5. A packet assembly control block 13 controls operations for reassembling plural packets transmitted thereto from the server 4 into a single packet. In response to instructions given from the packet assembly control block 13, a packet assembly block reassembles plural packets into a single packet, which is subjected to IP fragmentation in an IP fragmentation processing block 15. That is, the IP fragmentation processing block 15 divides each packet from the packet assembly block 14 into prescribed lengths, which are transmittable via the downstream satellite line 6.

The Internet line adaptive communicator 12 has bidirectional communication functions. That is, it outputs packets transmitted thereto from the server 4 to the packet assembly block 14, and it also outputs packets received by the satellite line adaptive communicator 11 to the server 4. As described above, the Internet line adaptive communicator 12 has agency functions of reception acknowledgement responses, wherein with respect to packets that were transmitted from the server 4 to the terminal 31, it produces and promptly transmits ACK packets before completion of reception of ACK packets from the terminal 31.

Similarly, the satellite line adaptive communicator 11 has bidirectional communication functions. That is it transmits packets, which are output from the IP fragmentation processing block 15, towards the terminal 31, and it also outputs packets transmitted thereto from the terminal 31 to the Internet line adaptive communicator 12. Herein, the satellite line adaptive communicator 11 discards ACK packets attached to received packets given from the terminal 31 via the upstream satellite line 7.

The packet assembly control block 13 received from the satellite line adaptive communicator 11 the maximal segment size (namely, ‘mss’; the maximal amount of transferable data per each packet) and the reception window size (namely, ‘win’: the maximal amount of receivable data), which are notified from the terminal 31. In addition, it provides satellite line adaptive communicator 11 with the information representative of the maximal segment size (mss) and reception window size (win), which should be notified to the terminal 31. Further, the packet assembly control block 13 communicates the information representative of the maximal segment size (mss) and reception window size (win) to the server 4 via the Internet line adaptive communicator 12. Based on this information, the packet assembly control block 13 determines the maximal amount of storable data per each packet transmitted towards the terminal 31. In addition, it notifies the packet assembly block 14 of the maximal amount of storable data, thus controlling operations of assembling packets.

Thus, the packet assembly block 14 reassembles plural packets given from the Internet line adaptive communicator 12 into a single packet within the range of the maximal amount of storable data, which is notified from the packet assembly control block 13.

The IP fragmentation processing block 15 proceeds to the processing of IP fragmentation with respect to packets output from the packet assembly block 14, which are divided into small-size packets each having a transmittable length via the downstream satellite line 6.

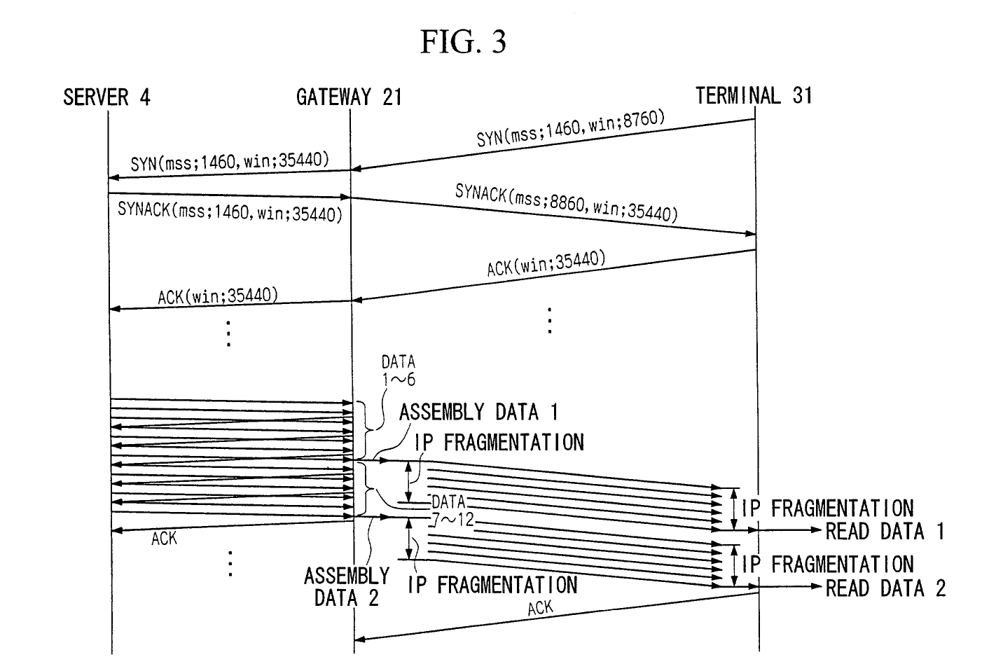

Next, a detailed description will be given with respect to packet repeating processing of the gateway 21 repeating and transmitting packets from the server 4 to the terminal 31. FIG. 3 shows relationships of operations of the server 4, gateway 21, and terminal 31, wherein the gateway 21 reassembles plural packets transmitted thereto from the server 4 into a single packet, which is transmitted to the terminal 31. In FIG. 3, various values are shown with respect to the maximal segment size (mss) and the reception window size (win) respectively, wherein these values are merely examples that are used to explain operations of the present embodiment.

In order to establish a TCP connection between the terminal 31 and the server 4, the terminal 31 firstly transmits a SYN packet, which is transmitted to the gateway 21 via the upstream satellite line 7. This SYN packet defines the property of the terminal 31 in such a way that the maximal segment size (mss) is set to 1460 bytes, and the reception window size (win) is set to 8760 bytes.

In the gateway 21 shown in FIG. 2, the packet assembly control block 13 detects from the satellite line adaptive communicator 11 the property of the terminal 31 that is notified by the SYN packet, namely, the maximal segment size (mss: 1460 bytes) and the reception window size (win: 8760 bytes). Herein, the packet assembly control block 13 instructs the Internet line adaptive communicator 12 to notify the server 4 of a greater reception window size (win: 35440 bytes) that is greater than the actual reception window size (win: 8760 bytes) of the terminal 31. Herein, the maximal segment size (mss: 1460 bytes) is retained and is directly notified to the server 4.

In accordance with the aforementioned instruction from the packet assembly control block 13, the Internet line adaptive communicator 12 attaches the information representing the maximal segment size (mss: 1460 bytes) and the reception window size (win: 35440 bytes) to the SYN packet, which is transmitted to the server 4 over the Internet 5.

Upon reception of the SYN packet from the gateway 21, the server 4 returns a SYN response acknowledgement packet (i.e., SYNACK packet) accompanied with the information representing the maximal segment size (mss: 1460 bytes) and the reception window size (win: 35440 bytes). This SYNACK packet is transmitted to the gateway 21 over the Internet 5, wherein the packet assembly control block 13 detects from the Internet line adaptive communicator 12 the information representing the maximal segment size (mss: 1460 bytes) and the reception window size (win: 35440 bytes). Then, the packet assembly control block 13 provides the SYNACK packet with the information representing the reception window size (win: 35440 bytes) and a greater maximal segment size (mss: 8860 bytes), which is greater than the maximal segment size (mss: 1460 bytes) originally attached to the SYNACK packet from the server 4. This SYNACK packet is transmitted to the terminal 31 via the downstream satellite line 6.

As described above, the packet assembly control block 13 of the gateway 21 communicates to notify the terminal 31 of the expected use of an ‘available’ maximal segment size (mss: 8860 bytes) that is increased to be greater than the original maximal segment size (mss: 1460 bytes), which was originally notified from the terminal 31 using the SYN packet. In this case, if the maximal segment size originally notified from the terminal 31 using the SYN packet runs short of the available maximal segment size that would be expected to be used by the terminal 31, the gateway 21 notifies the terminal 31 of a greater reception window size that is increased to be greater than the original reception window size. Normally, the terminal 31 may require a relatively large reception window size that is four times greater than the maximal segment size. In the case of FIG. 3, the terminal 31 originally notifies the gateway 21 of the reception window size (win: 8760 bytes), which does not match the four-times value of the maximal segment size (mss: 8860 bytes). Hence, the gateway 21 notifies the terminal 31 of the ‘four-times’ reception window size (win: 35440 bytes), which is attached to the SYNACK packet and is four times greater than the maximal segment size (mss: 8860 bytes).

Next, the terminal 31 returns an ACK packet having the information representing the ‘four-times’ reception window size (win: 35440 bytes), which is transmitted to the gateway 21 via the upstream satellite line 7. In the gateway 21, the packet assembly control block 13 communicates this reception window size (win: 35440 bytes) to the server 4 over the Internet 5. Thus, a TCP connection is completely established between the server 4 and the terminal 31 by using the aforementioned reception window size (win: 35440 bytes).

In the above, the packet assembly control block 13 may expect to use the available maximal segment size under the condition where the original reception window size of the terminal 31 runs short of the available maximal segment size. In the case of FIG. 3, the terminal 31 returns the great reception window size (win: 35440 bytes), which is four times greater than the available maximal segment size (mss: 8860 bytes). Hence, the aforementioned condition is satisfied, so that the packet assembly control block 13 defines the maximal segment size (mss: 8860 bytes) as the maximal amount of storable data per one packet, which is transmitted to the terminal 31. Thus, the packet assembly control block 13 notifies the packet assembly block 14 of the maximal amount of storable data (i.e., 8860 bytes).

When the present reception window size of the terminal 31 runs short of the available maximal segment size that would be expected to be used by the terminal 31, the packet assembly control block 13 determines that the available maximal segment size cannot be used for the terminal 31. In this case, the packet assembly control block 13 defines the original maximal segment size (mss: 1460 bytes), which was originally notified from the terminal 31 and was directly retransmitted to the server 4, as the maximal amount of storable data per one packet, which is transmitted to the terminal 31. Then, the packet assembly control block 13 sends the maximal amount of storable data (i.e., 1460 bytes) to the packet assembly block 14. Hence, the packet assembly block 14 directly outputs packets, which are transmitted thereto from the server 4 in accordance with the maximal segment size (mss: 1460 bytes). That is, the packet assembly block 14 does not perform reassembling plural packets into a single packet.

Next, the server 4 proceeds to transmission of six data packets (namely, ‘DATA1’ to ‘DATA6’) each describing TCP data in accordance with the maximal segment size (mss: 1460 bytes). These data packets DATA1-DATA6 are transmitted to the gateway 21 over the Internet 5, wherein they are received by the Internet line adaptive communicator 12. Due to the provision of agency functions of reception acknowledgement responses, the Internet line adaptive communicator 12 provisionally sends back one reception acknowledgement packet (ACK packet) every time it receives two data packets. Similarly, the server 4 is merely required to issue reception acknowledgement upon reception of two data packets. Further, the terminal 21 performs the same operation with respect to reception acknowledgement.

When completely receiving six data packets DATA1-DATA6 via the Internet line adaptive communicator 12, the packet assembly block 14 extracts TCP data from each of the six data packets; then, it puts together six TCP data to form ‘assembly data 1’ (representing 8760 bytes). Then, the packet assembly block 14 produces and outputs a data packet describing the assembly data 1. As described above, the packet assembly block 14 collects plural TCP data contained in plural data packets within the range of the maximal amount of storable data, so that it puts them together in the form of assembly data, which is stored in one data packet.

The IP fragmentation processing block 15 performs IP fragmentation with respect to the data packet output from the packet assembly block 14, so that the data packet is divided into plural packets whose lengths are transmittable via the downstream satellite line 6. These packets are transmitted to the terminal 31 via the downstream satellite line 6, wherein they are subjected to IP defragmentation so that plural packets are reassembled into a single data packet. Then, the terminal 31 reads TCP data (referred to as ‘read data 1’) from the data packet. The read data 1 matches the assembly data 1.

Thereafter, the packet assembly block 14 receives the next set of six data packets (namely, ‘DATA7’ to ‘DATA12’) via the Internet line adaptive communicator 12, so that the packet assembly block 14 collects six TCP data described in the six data packets DATA7-DATA12 and puts them together in the form of assembly data 2 (representing 8760 bytes). Then, the packet assembly block 14 produces and outputs a data packet describing the assembly data 2. This data packet is subjected to IP fragmentation in the IP fragmentation processing block 15, so that it is divided into plural packets whose lengths are transmittable via the downstream satellite line 6. The terminal 31 receives the plural packets, which are subjected to IP defragmentation and are collected together as a single data packet. Then, the terminal 31 reads TCP data (referred to as ‘read data 2’) described in the data packet. The read data 2 matches the assembly data 2.

With respect to twelve data packets DATA1-DATA12 originally transmitted from the server 4, the terminal 31 receives two data packets describing the assembly data 1 and 2 respectively. Upon reception of these two data packets, the terminal 31 sends back one ACK packet onto the upstream satellite line 7 towards the gateway 21.

If the gateway 21 directly passes twelve data packets DATA1-DATA12 transmitted thereto from the server 4 without assembling them, the terminal 31 should send back six ACK packets because the terminal 31 is designed to send back one ACK packet upon reception of two data packets. However, the gateway 21 is designed in such a way that each set of six data packets are assembled together in association with assembly data, so that the terminal 31 is merely required to handle a single data packet. Specifically, the terminal 31 merely sends back only one ACK packet with respect to the total twelve data packets originally transmitted from the server 4. This contributes to noticeable reduction in issuance of reception acknowledgement responses in the terminal 31. Thus, it is possible to remarkably reduce the frequency band for use in the upstream satellite lines 7. As a result, it is possible to reliably ease the congestion in the upstream satellite lines 7.

As described above, this invention can demonstrate remarkable effects in asymmetrical transmissions in which data transmission speeds in upstream satellite lines are very small compared with data transmission speeds in downstream satellite lines, wherein it is possible to reliably ease the congestion in upstream satellite lines. Therefore, it is possible to improve the throughput in transmissions of TCP data.

As described heretofore, this invention provides a variety of effects and technical features, which will be described below.

(1) The packet repeater (e.g., gateway) of this invention is designed in such a way that specific data extracted from plural packets are collected together and are stored in a single transmission packet, which is transmitted towards the receiver (e.g., terminal) via the downstream satellite line. This contributes to a reduction in the total number of packets received by the receiver. Therefore, it is possible to reduce the number of reception acknowledgement response packets (ACK packets), which should be returned from the receiver upon reception of packets. Hence, it is possible to reliably reduce the congestion in upstream lines through which the receiver sends ACK packets and the like. As a result, it is possible to reduce the retransmission frequency of packets, which occur due to the congestion. Thus, it is possible to improve the data transmission efficiency.

(2) By increasing the maximal amount of storable data per one transmission packet to be greater than the maximal segment size notified from the receiver, it is possible to further decrease the number of packets received by the receiver; therefore, it is possible to further decrease the number of ACK packets that the receiver should return. This contributes to a further reduction of the occurrence of the congestion in upstream lines directed from the receiver to the server. Therefore, it is possible to further reduce the retransmission frequency of packets due to the congestion. As a result, it is possible to further improve the data transmission efficiency.

(3) The packet repeater (e.g., gateway) can adequately assemble plural packets together based on the maximal amount of storable data under the condition where the reception window size notified from the receiver fulfills the maximal amount of storable data. That is, it is possible to integrate plural packets into a single transmission packet in response to the reception ability of the receiver. In this case, it is possible to avoid occurrence of unwanted retransmission of transmission packets, regardless of the situation where the integrated transmission packet integrating plural packets is mistakenly transmitted to the receiver even though the receiver cannot receive the integrated transmission packet over the reception ability.

(4) By notifying the receiver of the desired reception window size that fulfills the maximal amount of storage data per one transmission packet in advance, the gateway can adequately adjust the reception window size to be used for the receiver. This may raise the possibility of using the integrated transmission packet integrating plural packets. In other words, this may contribute to a reduction of the congestion in upstream lines as well. As a result, it is possible to reduce the retransmission frequency of packets due to the congestion. Hence, it is possible to improve the data transmission efficiency.

(5) The gateway has agency functions of reception acknowledgement responses, wherein an ACK packet is provisionally sent back to the transmitter with respect to the prescribed number of packets transmitted from the transmitter via the prescribed transmission line. That is, it is possible to increase the reception speed of packets transmitted from the transmitter. This may increase the number of packets to be integrated into a single transmission packet. Hence, it is possible to further reduce the congestion in upstream lines by further reducing the number of packets actually received by the receiver. As a result, it is possible to further improve the data transmission efficiency.

(6) Due to the integrated transmission of this invention in which plural packets are integrated into a single transmission packet that is transmitted to the receiver, it is possible to reduce the amount of data regarding headers and footers in comparison with the direct transmission in which plural packets are directly transmitted to the receiver. Thus, it is possible to further improve the data transmission efficiency.

(7) This invention can demonstrate the aforementioned effects particularly in the case of an integrated digital network system in which a server is interconnected with a gateway via a first communication network (e.g., Internet), and the gateway is interconnected with terminals via a second communication network (e.g., satellite lines) where upstream lines are reduced in data transmission speeds compared with downstream lines.

As this invention may be embodied in several forms without departing from the spirit or essential characteristics thereof, the present embodiment is therefore illustrative and not restrictive, since the scope of the invention is defined by the appended claims rather than by the description preceding them, and all changes that fall within metes and bounds of the claims, or equivalents of such metes and bounds are therefore intended to be embraced by the claims.

What is claimed is:

1. A packet repeater applicable to an integrated digital network system which incorporates a first network and a second network comprising an upstream line and a downstream line which are asymmetrical with respect to each other in data transmission speed, said packet repeater comprising:
a first network adaptive communicator for allowing bidirectional communications of packets via the first network;
a second network adaptive communicator for allowing bidirectional communications of packets via the second network; and
a packet assembler for extracting a plurality of specific data from a plurality of packets received by the first network adaptive communicator and for assembling together the plurality of specific data into a single transmission packet, which is transmitted by the second network adaptive communicator.

2. A packet repeater according to claim 1, wherein the upstream line is reduced in data transmission speed compared with the downstream line.

3. A packet repeater according to claim 1, wherein the first network is the Internet, and the second network is a satellite communication network.

4. A packet repeater according to claim 1, wherein the specific data is TCP data.

5. A packet repeater according to claim 1 further comprising a packet assembly controller for controlling the packet assembler in such a way that a maximal amount of storable data per one transmission packet is increased to be greater than a maximal segment size notified from a receiver interconnected with the second network.

6. A packet repeater according to claim 5, wherein the packet assembly controller instructs the packet assembler to assemble together the plurality of packets in the form of the single transmission packet on the basis of the maximal amount of storable data under the condition where the reception window size notified from the receiver fulfills the maximal amount of storable data.

7. A packet repeater according to claim 5, wherein the packet assembly controller notifies the receiver of the reception window size that fulfills the maximal amount of storable data in advance.

8. A packet repeater according to claim 1 further comprising a reception acknowledgement response agency for provisionally sending back a reception acknowledgement response in reply to a prescribed number of packets transmitted via the first network before receiving a reception acknowledgement response from the receiver receiving the transmission packet.

9. A packet repeater according to claim 5 further comprising a reception acknowledgement response agency for provisionally sending back a reception acknowledgement response in reply to a prescribed number of packets transmitted via the first network before receiving a reception acknowledgement response from the receiver receiving the transmission packet.

10. A packet repeater according to claim 6 further comprising a reception acknowledgement response agency for provisionally sending back a reception acknowledgement response in reply to a prescribed number of packets transmitted via the first network before receiving a reception acknowledgement response from the receiver receiving the transmission packet.

11. A packet repeater according to claim 7 further comprising a reception acknowledgement response agency for provisionally sending back a reception acknowledgement response in reply to a prescribed number of packets transmitted via the first network before receiving a reception acknowledgement response from the receiver receiving the transmission packet.

12. A packet repeater method applicable to an integrated digital network system which incorporates a first network and a second network comprising an upstream line and a downstream line which are asymmetrical with respect to each other in data transmission speed, said packet repeater method comprising the steps of:
receiving a plurality of packets via the first network;
extracting a plurality of specific data from the plurality of packets received via the first network;
assembling together the plurality of specific data into a single transmission packet; and
transmitting the transmission packet via the second network.

13. A packet repeater method according to claim 12, wherein the upstream line is reduced in data transmission speed compared with the downstream line.

14. A packet repeater method according to claim 12, wherein the first network is the Internet, and the second network is a satellite communication network.

15. A packet repeater method according to claim 12, wherein the specific data is TCP data.

16. A packet repeater method according to claim 12 further comprising the steps of:
receiving a maximal segment size notified from a receiver interconnected with the second network; and
setting a maximal amount of storable data per one transmission packet to be greater than the maximal segment size notified from the receiver.

17. A packet repeater method according to claim 16 further comprising the steps of:
receiving a reception window size notified from the receiver; and
assembling together the plurality of packets in the form of the single transmission packet on the basis of the maximal amount of storable data under the condition where the reception window size notified from the receiver fulfills the maximal amount of storable data.

18. A packet repeater method according to claim 17 further comprising the step of:
notifying the receiver of the reception window size that fulfills the maximal amount of storable data in advance.

19. A packet repeater method according to claim 12 further comprising the step of:
provisionally sending back a reception acknowledgement response in replay to a prescribed number of packets transmitted via the first network before receiving a reception acknowledgement response from the receiver receiving the transmission packet.

20. A packet repeater method according to claim 16 further comprising the step of:
provisionally sending back a reception acknowledgement response in reply to a prescribed number of packets transmitted via the first network before receiving a reception acknowledgement response from the receiver receiving the transmission packet.

21. A packet repeater method according to claim 17 further comprising the step of:
provisionally sending back a reception acknowledgement response in reply to a prescribed number of packets transmitted via the first network before receiving a reception acknowledgement response from the receiver receiving the transmission packet.

22. A packet repeater method according to claim 18 further comprising the step of:
provisionally sending back a reception acknowledgement response in reply to a prescribed number of packets transmitted via the first network before receiving a reception acknowledgement response from the receiver receiving the transmission packet.
